(19) United States
(12) Patent Application Publication
(10) Pub. No.: US 2026/0211507 A1
(43) Pub. Date: Jul. 23, 2026

(54) METHOD, APPARATUS, DEVICE AND STORAGE MEDIUM FOR AUGMENTED REALITY

(71) Applicant: Beijing Zitiao Network Technology Co., Ltd., Beijing (CN)

(72) Inventors: Zhenghao GUAN, Beijing (CN); Sijing WEN, Beijing (CN); Qiuting LI, Beijing (CN); Zheng WEI, Beijing (CN); Jialiang LI, Beijing (CN); Gaojie LIN, Beijing (CN)

(21) Appl. No.: 19/142,135

(22) PCT Filed: Dec. 8, 2023
(86) PCT No.: PCT/CN2023/137571

§ 371 Date: Jun. 20, 2025

(30) Foreign Application Priority Data
Dec. 21, 2022 (CN) 202211651964.3

(51) Int. Cl. G06F 3/01; G06T 19/00

(52) U.S. Cl. CPC G06F 3/017; G06T 19/006

(57) ABSTRACT

The disclosure provides a method, apparatus, device and a computer readable storage medium for augmented reality, AR. In the method, a target gesture made by a user is detected. At least one finger of the user has a predetermined shape in the target gesture. In response to detecting the target gesture, an avatar is presented in an AR environment. At least a portion of the avatar matches a predetermined shape in appearance. In response to detect a change of the target gesture, an action of the avatar is controlled in the AR environment based at least on the change. In this way, the AR effect of the avatar may be enhanced.

This application claims the benefit of China Patent Application No. 202211651964.3 entitled “METHOD, APPARATUS, DEVICE AND STORAGE MEDIUM FOR AUGMENTED REALITY,” filed Dec. 21, 2022, the entire content of which is incorporated herein by reference.

### FIELD

Example embodiments of the present disclosure generally relate to information processing, and more particularly, to a method, apparatus, device and computer-readable storage medium for augmented reality.

### BACKGROUND

With continuous development of computer vision technology, Augmented Reality (AR) technology has been widely used in various fields such as medical, tourism, exhibition, shopping and entertainment. Using the AR technology, physical information such as visual, sound, taste, and tactile sensation can be simulated to generate virtual information. The generated virtual information may be superimposed into the real world to provide a user with an AR environment containing a combination of real and virtual objects. Objects in a surrounding environment can be identified, virtualized, and presented with AR effects by means of a dedicated AR device, or by means of a processor, camera, and display of a mobile phone. It is important to enable a presentation of an optimized AR effect to the user.

### SUMMARY

In a first aspect of the present disclosure, a method of augmented reality (AR) is provided. The method comprises the steps of detecting a target gesture made by a user, at least one finger of the user having a predetermined shape in the target gesture; in response to detecting the target gesture, presenting a avatar in the AR environment, at least a portion of the avatar matching the predetermined shape in appearance; and in response to detecting a change of the target gesture, controlling an action of the avatar in the AR environment based at least on the change.

In a second aspect of the present disclosure, an apparatus for augmented reality (AR) is provided. The apparatus comprises a gesture detection module, a presentation module and a first control module, wherein the gesture detection module is configured to detect a target gesture made by a user, and the at least one finger of the user has a predetermined shape in the target gesture; the presentation module is configured to in response to detecting the target gesture, present the avatar in the AR environment, at least a portion of the avatar matches the predetermined shape in appearance; and the first control module is configured to in response to detecting a change of the target gesture, control the action of the avatar in the AR environment at least based on the change.

In a third aspect of the present disclosure, an electronic device is provided. The electronic device includes at least one processing unit; and at least one memory coupled to the at least one processing unit and storing instructions for execution by the at least one processing unit. The instructions, when executed by the at least one processing unit, cause the electronic device to perform the method according to the first aspect of the present disclosure.

In a fourth aspect of the present disclosure, a computer-readable storage medium is provided. The computer-readable storage medium stores a computer program, and the computer program is executable by the processor to perform the method according to the first aspect of the present disclosure.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 shows a flowchart of an AR presentation process according to some embodiments of the present disclosure;

FIG. 3A to FIG. 3J are schematic diagrams of AR effects of an avatar according to some embodiments of the present disclosure;

FIG. 4 illustrates a schematic diagram of an example simulation structure of an elastic portion of an avatar according to some embodiments of the present disclosure;

FIG. 5A illustrates a schematic diagram of a posture of an elastic portion of an avatar without considering gravity according to some embodiments of the present disclosure;

FIG. 5B illustrates a schematic diagram of a posture of an elastic portion of an avatar under the action of gravity according to some embodiments of the present disclosure.

FIG. 6 shows a schematic structural block diagram of an apparatus for AR according to some embodiments of the present disclosure; and

FIG. 7 shows a block diagram of an electronic device that can be used to implement some embodiments of the present disclosure.

### DETAILED DESCRIPTION

Embodiments of the present disclosure will be described in more detail below with reference to the accompanying drawings. While some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

The term “in response to” means that a corresponding event occurs or condition is satisfied. It will be appreciated that the timing of execution of subsequent actions performed in response to the event or condition is not necessarily strongly correlated with the time at which the event occurs or the condition is satisfied. In some cases, subsequent actions may be performed immediately when an event occurs or a condition holds; in other cases, subsequent actions may also be performed after a period of time after an event occurs or a condition holds.

It may be understood that the data involved in the technical solution (including but not limited to the data itself, the obtaining or use of the data) should follow the requirements of the corresponding laws and regulations and related regulations.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

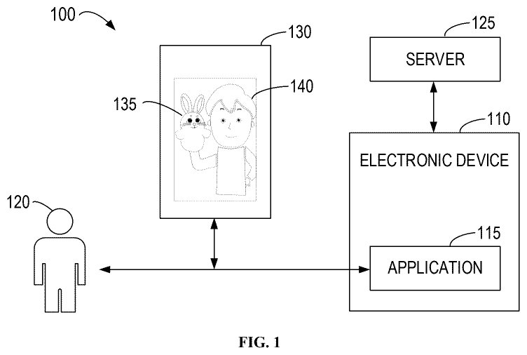

FIG. 1 illustrates a schematic diagram of an example environment 100 in which embodiments of the present disclosure can be implemented.

In this example environment 100, an application 115 is installed in an electronic device 110. A user 120 may interact with the application 115 via the electronic device 110 and/or an attachment device of the electronic device 110. The application 115 may be various types of applications such as a social application, a news application, a shopping application, an entertainment application, a financial application, a life application, a tool application, and the like, and can provide various services including AR presentations to the user 120.

The electronic device 110 may be any type of terminal devices such as a mobile terminal, a fixed terminal or a portable terminal, which include a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, and include accessories and peripherals of these devices, or any combination thereof. In some embodiments, the electronic device 110 can also support any type of interfaces for a user (such as a “wearable” circuit, and the like).

In some embodiments, the electronic device 110 communicates with a server 125 to provide services of the application 115. The server 125 may be implemented by any type of device, including virtual and physical devices. Examples of such devices may include, but are not limited to, mainframes, edge computing nodes, rack servers, router computers, server computers, personal computers, mainframe computers, laptop computers, tablet computers, desktop computers, and the like. In some embodiments, the device may include a virtual machine, a container, or a bare metal server.

It should be understood that the structure and function of the environment 100 is described for the purposes of illustrations, without suggesting any limitation on the scope of the present disclosure.

In environment 100, AR presentations including an avatar 135 and a user image 140 may be provided to the user 120 on a user interface 130 of the electronic device 110. As an example, the avatar 135 is shown as a virtual cartoon rabbit. As shown in FIG. 1, a cartoon rabbit may be sleeved on a hand of the user image 140 like a glove. The avatar 135 may also be a virtual cat, a virtual dog, a virtual deer, or other virtual animals, such as one of the twelve animal zodiacs. Alternatively or additionally, the avatar 135 may be a person or an object.

In the AR presentation process, it is desirable to provide enhanced control of the avatar for the user to enhance the AR effect.

Embodiments of the invention provide an AR solution. According to the solution, a change of a user gesture is combined with an action of an avatar, to use the user gesture to control the action of one or more portions of the avatar that match are similar to a shape of the gesture in appearance. In this way, the user may have higher control on the avatar and higher freedom of control may be provided for the user. Therefore, the flexibility of controlling the avatar is improved, and the user experience is improved.

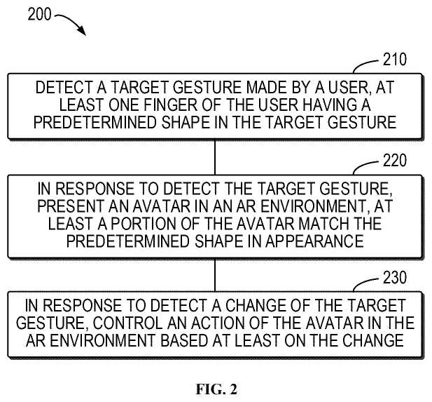

FIG. 2 illustrates an AR presentation process 200 according to some embodiments of the present disclosure. The process 200 may be performed by the electronic device 110. For the purpose of discussion, the process 200 will be described with reference to FIG. 1.

At block 210, a target gesture made by the user 120 is detected, and at least one finger of the user 120 has a predetermined shape in the target gesture. In some embodiments, the user 120 may make this target gesture with two or more fingers. With this shape of the gesture, the user 120 may control the avatar 135 in the AR environment.

At block 220, in response to detecting the target gesture, the avatar 135 is presented in the AR environment, and at least a portion of the avatar 135 matches the predetermined shape in appearance. For example, as shown in FIG. 1, in an embodiment in which the avatar 135 is a rabbit glove sleeved on a hand of the user image 140, the user 120 may make a V-shaped gesture (e.g., a victory gesture) with two fingers to match and control the ears of the rabbit.

The user 120 may also use other gestures to match and control one or more portions of other examples of the avatar 135. For example, the user 120 may use four fingers to match and control two ears and two antlers of a virtual deer. For another example, the user 120 may use a plurality of fingers to match and control beard of a cartoon cat.

At block 230, in response to detecting a change in the target gesture, an action of the avatar 135 in the AR environment is controlled based at least on the change. In this way, the user 120 may flexibly and efficiently control motion of the avatar 135 by a gesture that visually matches a part of the avatar 135.

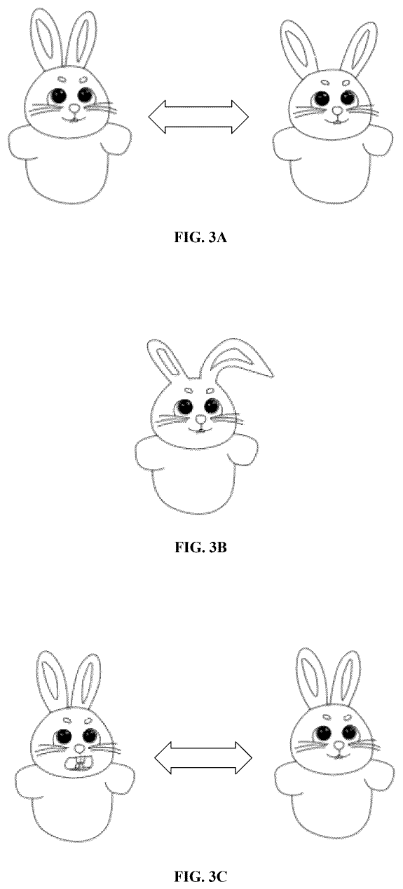

In some embodiments, an angle between a first component and a second component of the at least a portion of the avatar 135 may be controlled based on a change in an angle between two or more fingers involved in the gesture of the user 120. For example, in an embodiment in which the user 120 controls the ears of a virtual rabbit with a victory gesture, the index and middle fingers of the user 120 may control two ears of the rabbit, respectively, which are a first component and a second component of the rabbit ear, respectively. In this embodiment, the user 120 may change the angle of the two ears by changing the angle between the index finger and the middle finger. As shown in FIG. 3A, as the angle between the index finger and the middle finger of the user 120 increases, the angle between the ears of the rabbit also increases correspondingly.

In some embodiments, bending of at least one component of the at least a portion may be controlled based on bending of at least one of the two or more fingers of the user 120. For example, in embodiments where the user 120 controls two ears of the rabbit with an index finger and a middle finger, respectively, one and/or two ears of the rabbit may be bent by bending the index finger and/or the middle finger. As shown in FIG. 3B, the user 120 may bend the left ear of the rabbit by bending the index finger.

By matching and controlling the actions (such as translating, rotating, bending, and the like) of the corresponding components of the avatar 135 with different fingers, the operation of the user 120 is more convenient and more flexible, thereby further improving the user experience.

Alternatively or additionally, in embodiments where the avatar 135 is a virtual rabbit glove, the user 120 may control the opening of the rabbit's mouth by pinching of two or more fingers (e.g., index and middle fingers). For example, finger opening may correspond to the opening of a mouth of the rabbit, finger converging or merging may correspond to closing of the mouth of the rabbit, as shown in FIG. 3C. In this way, the user 120 may use two or more fingers (for example, an index finger and a middle finger) to control various actions of a plurality of portions of the avatar 135, for example, may control changes of the ears and mouth of the virtual rabbit at the same time, further enhancing the controllability of the avatar 135 by the user 120.

In some embodiments, the avatar 135 may move in the AR environment by following movement of the hand of the user 120 that makes the target gesture. In some embodiments, an orientation of the avatar 135 in the AR environment may be controlled based on a rotation of the hand. For example, the orientation of the avatar 135 (e.g., the virtual rabbit glove in FIG. 1) may change with the rotation of the hand of the user 120. As an example, a front face of the avatar 135 may be displayed when the user 120 makes a forehand victory. When the user 120 turns toa backhand victory, the avatar 135 also turns to its back face.

In order to further optimize the AR effect of the avatar 130, in some embodiments, the orientation of the avatar 130 may be modified. For example, after determining the orientation of the avatar 135 in the AR environment based on the rotation of the hand of the user 120, the orientation of the avatar 135 may be modified by using an orientation calibration factor, so that the predetermined face (e.g., the front face) of the avatar 135 rotates a certain angle towards a presentation interface (e.g., the user interface 130) of the AR environment. Thereafter, the avatar 135 may be presented in the AR environment according to the modified orientation. In this way, it is possible to correct or calibrate the change in the orientation of the avatar 135 caused by instability of the hand posture of the user 120 or gesture differences due to individual differences among different users.

For example, in an embodiment where the user 120 controls a virtual rabbit glove as an example of the avatar 135 with a victory gesture, the orientation of a palm of user 120 may not be consistent with the orientation of the user interface 130 when making the victory gesture. A rotation angle of the hand of the user 120 may be modified by a weighting operation. For example, one weight may be applied to the orientation of the avatar 135 determined by the rotation angle of the hand, and another weight may be applied to the orientation of the avatar 135 towards the user interface 130. For example, the values of the weights may be 0.6 and 0.4, respectively. The specific value of the weight may depend on the particular implementation. Through the orientation modification described above, the front face of the avatar 135 may rotate a certain angle towards the orientation of the user interface 130. In this way, an orientation offset of the avatar 135 caused by the instability of hand gestures of the user 120 may be reduced.

As shown in FIG. 3D, due to a slight deflection of the hand of the user 120 when making a gesture, the face of the virtual rabbit does not face towards the user interface 130, but deflected. After the modification, as shown in FIG. 3E, the face of the rabbit is rotated towards the user interface 130, so that the face of the rabbit appears more towards the user interface 130.

In some embodiments, the user 120 may trigger and stop presentation of the avatar 135 by a gesture. For example, if the bending of two or more fingers of the user 120 is detected to exceed a threshold degree, e.g., to be approximate to a first gesture, the avatar 135 may be stopped being displayed in the AR environment. The threshold degree may be set according to actual needs. In some embodiments, the presentation of the avatar 135 may be triggered upon recognizing a predetermined gesture of the user 120. For example, the vector gesture of the user 120 may trigger presentation of a virtual rabbit glove (as shown in FIG. 1) as an example of the avatar 135.

In addition to controlling the action of the avatar 135, the user 120 may also control an expression of the avatar 135 through the gesture to further enhance the controllability of the avatar 135 by the user 120 and optimize the AR effect of the avatar 135. In some embodiments, in response to detecting a change in the target gesture of the user 120, the expression of the avatar 135 may be controlled based at least on the change. The expression may include a wide variety of expressions such as normal, ecstatic, aggrieved, angry, surprised and the like, as shown in FIG. 3F. Therefore, the gesture may be combined with the action and the expression of the avatar 135 to provide more emotional expression for the avatar 135, thereby providing a higher degree of freedom and higher playability for the user 120.

In some embodiments, the user 120 may switch between different expressions of the avatar 135 with different degrees of bending of the finger(s). For example, different degrees of bending may correspond to different expressions. In some embodiments, the switching of the expressions may require a predetermined number of fingers to control. For example, in embodiments where the user 120 controls the ears of a virtual rabbit with two fingers (e.g., index and middle fingers), each finger may individually control one ear. In this case, the expression of the avatar 135 may be controlled by bending of two fingers, and the bending of a single finger may not cause an expression change of the avatar 135.

In some embodiments, the bending change of the finger may simultaneously trigger a change of an expression of the avatar 135 and a bending change of at least one component of the avatar 135. For example, in an embodiment in which the user 120 controls the ears of the virtual rabbit with two fingers (for example, an index finger and a middle finger), when the two fingers of the user 120 is vertical, an expression of the avatar 135 may be switched to be happy, while a specific component of the avatar 135, for example, two ears of a virtual rabbit, may be correspondingly in an upright state. In this way, the bending of the two fingers can simultaneously control the bending of the ears of the rabbit and the change of the expression of the rabbit. The bending of a single finger may control the bending of a single rabbit ear without changing the expression of the rabbit.

Alternatively or additionally, the user 120 may trigger a switch of the expression of the avatar 135 by a predetermined gesture. For example, if the banding of two or more fingers of the user 120 are detected to exceed a threshold degree, e.g., to be approximate to a first gesture, it may trigger a switch of the expression of the avatar 135. The threshold degree may be set according to actual needs. In this way, the bending of the finger of the user 120 may trigger the change of the expression of the avatar 135 once. This way of switching the expressions is more convenient and more controllable.

In some embodiments, in addition to using the gestures, the user 120 may also use a facial expression to control presentation of the avatar 135 in the AR environment. For example, a action and/or expression of the avatar 135 in the AR environment may be controlled according to the detected facial expression of the user 120. In this way, the user 120 can be enable to more flexibly and conveniently control the AR presentation of the avatar 135.

In some embodiments, the user 120 may control the effects in the AR environment through gestures. For example, in response to detecting that the target gesture of the user 120 is changed to a different predetermined gesture, an effect corresponding to the predetermined gesture may be presented in the AR environment. As an example, the open palm of the user 120 may trigger effects such as red envelopes (as shown in FIG. 3G), best wishes (as shown in FIG. 3H), star eyes (as shown in FIG. 3I), and the like. Alternatively or additionally, an OK gesture by the user 120 may trigger the avatar 135 greeting the New Year with both hands, best wishes for New Yea and/or other effects. Alternatively or additionally, a number six gesture of the user 120 may trigger an effect such as the avatar 135 holding a couplet with each hand (as shown in FIG. 3J). Alternatively or additionally, rapid shaking of the hand of the user 120 may trigger an effect such as bursting of red envelopes. A wide variety of gestures can be set to trigger different hidden Easter eggs, further enhancing playability and improving user experience.

In some embodiments, at least a portion of the avatar 135 may be elastic. For example, the ears of the virtual rabbit may be elastic. To further enhance the AR effect, the deformation of the elastic portion of the avatar 135 may be controlled based on a change in the gesture of the user 120 and a mechanical simulation (for example, including inertia, gravity, and the like) of the elastic portion of the avatar 135 that matches a shape of the gesture. In this way, the simulation of the elastic portion of the avatar 135 may be more in line with a mechanic principle, so that the AR presentation of the elastic portion is more realistic, thereby further enhancing the AR effect of the avatar 135.

In some embodiments, gravity and stress may be considered to control the deformation of the elastic portion of the avatar 135. For example, the first posture of the elastic portion may be determined based on the bending degree of the finger of the user 120. Simulated gravity and simulated stress of a plurality of predetermined nodes in the elastic portion may be calculated based on the first posture, and a bending angle of each of the plurality of segments of the elastic portion relative to the previous segment of the plurality of segments may be determined based on the simulated gravity and the simulated stress. The plurality of segments are defined by a plurality of nodes. The first posture of the initially determined elastic portion may be adjusted based on the determined bending angle to obtain a second posture of the elastic portion.

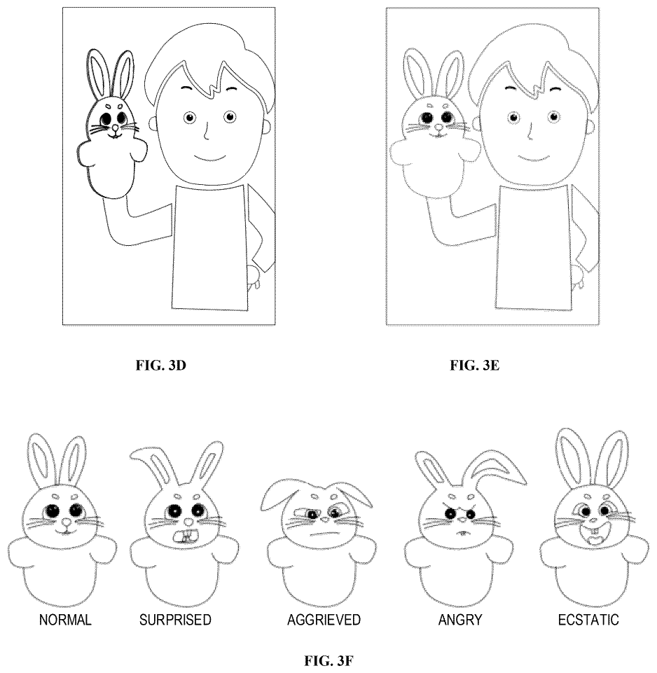

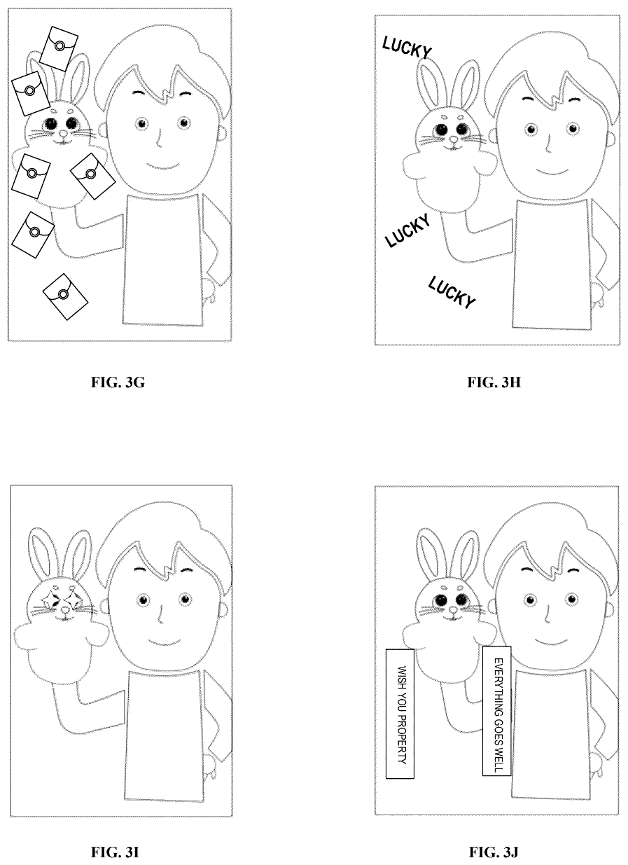

An example process of adjusting the deformation of the elastic portion of the avatar 135 in consideration of gravity and stress will be discussed below with reference to FIG. 4 and FIGS. 5A and 5B. In this example, the avatar 135 is a virtual rabbit, and the elastic portion is the ears of the rabbit.

FIG. 4 illustrates an example simulation structure 400 of the elastic portion of the avatar 135 according to some embodiments of the present disclosure.

As shown in FIG. 4, a gravity direction 402 may be selected as a downward direction to simulate a virtual rabbit standing on the ground. In this way, a capturing posture of the photographer may not be considered.

A rabbit ear may be abstracted to include a plurality of skeletal nodes, such as nodes 404, 406, 408, 410, and 412 shown in FIG. 4. Between every two nodes, such as the nodes 404 and 406, the nodes 406 and 408, the nodes 408 and 410, and the nodes 410 and 412, a segment is formed, and the formed segments are connected to each other. The varying information such as rotation, translation, and scaling of the individual skeletal nodes may be weighted to vertices, e.g., the node 412, to control the movement, rotation, and scaling of the vertices accordingly.

In operation, the initial first posture that is not affected by gravity may be first generated according to the bending degree of the finger of the user 120, and then the gravity and the stress each of the bone nodes 404, 406, 408, 410, and 412 experienced is calculated based on the gravity direction 402. The rotation may be considered while ignoring stretching. For example, rotation information for each bone node may be modified regardless of scaling and position changing. Thus, the bending of the rabbit ear can be simulated based on both control bending related to the gesture and gravity bending related to gravity.

Without considering the influence of gravity, as shown in FIG. 5A, a bending angle (also referred to as the bending angle of each level) 0 of each segment relative to a previous segment is consistent after the rabbit ear is controlled based on the bending of the finger of the user 120. After the effect of the gravity, is considered as shown in FIG. 5B, the bending angle of each level gradually approaches the gravity direction 402. A rotation angle or rotation information of a current level may be set based on the difference between bending angles of each level and the previous level.

Considering that the rabbit ear can be treated as a whole, stress can also be considered to determine a change in a rotation angle. The stress is a physical quantity that is mechanically used to describe the internal force of the material, which can be defined as the internal force on the unit area of the internal cross-section of the material. The source of the stress here may include shearing and bending. The more a segment bends, the more its bending angle deviates from an initial angle, the greater stress it encounters. For each level of the bending angle, an angle that balances stress and gravity can be selected. The bending angle of each level may be calculated level by level, and the first posture of the rabbit ear may be adjusted accordingly to obtain a second posture that considers gravity and stress.

In some embodiments, contribution of movement of a root of the rabbit ear and the bending of the ear to the rotation of a bone node may be considered. For example, the root of the ear may be fixed relative to the head of the rabbit, and the bending degree of ear may correspond to the bending degree of the finger. In embodiments where the virtual rabbit moves following movement of the hand of the user 120, a movement speed may be determined level by level. For example, the root of the ear may be one level that first follows the movement. Then, levels are divided from bottom to top, and the movement speeds are determined level by level. On a frame-by-frame basis, the respective speeds of the levels may be updated and the levels may be displayed at respective positions. The speed values and/or positions of the respective levels of each frame may be stored in a table.

To further enhance the AR effect of the avatar 135, in some embodiments, the deformation of at least a portion of the avatar 135 may be further controlled based on simulated resistance experienced in the AR environment. As an example, the following calculation formula for air resistance may be utilized:

$$F = ( 1 / 2 ) C ρ S {V}^{2}$$

where C represents an air resistance coefficient, ρ represents an air density, S represents a windward area of an object, and V represents a movement speed of the object relative to the air. The larger the velocity V, the greater reverse resistance is. By considering the simulated resistance, the rabbit ear can show a more floating effect in the movement process, and the AR effect is further enhanced.

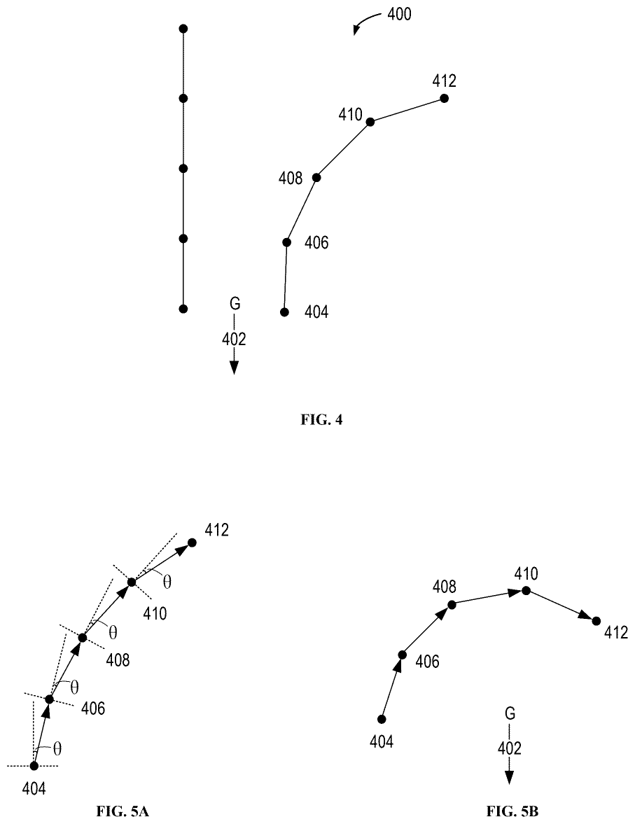

FIG. 6 is a schematic structural block diagram of an information processing apparatus 600 according to some embodiments of the present disclosure. The apparatus 600 may be implemented at the electronic device 110 in FIG. 1.

As shown in FIG. 6, the apparatus 600 includes a gesture detection module 610, a presentation module 620, and a first control module 630. The gesture detection module 610 is configured to detect a target gesture made by a user, where at least one finger of the user has a predetermined shape in the target gesture. The presentation module 620 is configured to, in response to detecting the target gesture, present an avatar in the AR environment, at least a portion of the avatar matching the predetermined shape in appearance. The first control module 630 is configured to, in response to detecting a change in the target gesture, control an action of the avatar in the AR environment based at least on the change.

In some embodiments, the at least one finger may comprise two or more fingers.

In some embodiments, the first control module 630 may be configured to control an angle between a first component and a second component of the at least a portion based on a change in an angle between two or more fingers.

In some embodiments, the first control module 630 may be configured to control the bending of at least a component of the at least one portion based on bending of at least one of the two or more fingers.

In some embodiments, the apparatus 600 may further include a stopping module configured to stop displaying the avatar in the AR environment in response to detecting that the bending of the two or more fingers each exceeds a threshold degree.

In some embodiments, the first control module 620 may be configured to control an orientation of the avatar in the AR environment based on a rotation of a hand making a target gesture.

In some embodiments, the first control module 620 may be configured to: determine the orientation of the avatar in the AR environment based on the rotation of the hand making the target gesture; and modify an orientation by using an orientation calibration factor, to cause a predetermined face of the avatar to rotate towards a presentation interface of the AR environment by a certain angle; and present the avatar in the AR environment according to the modified orientation.

In some embodiments, the apparatus 600 may further include an effect module configured to in response to detecting that the target gesture is changed to a different predetermined gesture, present an effect corresponding to a predetermined gesture in the AR environment.

In some embodiments, the apparatus 600 may further include a second control module configured to, in response to detecting a change in the target gesture, control an expression of the avatar at least based on a change.

In some embodiments, the apparatus 600 may further include an expression detection module configured to detect an expression of a face of the user; and a third control module configured to control an action and/or an expression of the avatar in the AR environment based on the detected expression of the face.

In some embodiments, at least a portion of the avatar may be elastic. In these embodiments, the first control module 630 may be configured to control the deformation of at least a portion based on a change of the gesture and a mechanical simulation associated with at least a portion of the avatar.

In some embodiments, the first control module 630 may be configured to: determining a first posture of at least a portion based on a bending degree of the finger; calculating, based on the first posture, simulated gravity and simulated stress of a plurality of predetermined nodes in at least a portion; determining a bending angle of each segment of the at least a portion with respect to a previous segment of the plurality of segments, based on the simulated gravity and the simulated stress, the plurality of segments being defined by a plurality of nodes; and adjusting the first posture according to the bending angle to obtain a second posture of the at least a portion.

In some embodiments, the first control module 630 may be configured to control the deformation further based on simulated resistance experienced by the at least a portion in the AR environment.

It should be understood that the features and corresponding effects related to the AR present operation discussed above with reference to FIG. 1, FIG. 2, FIG. 3A to FIG. 3J, FIG. 4, FIG. 5A, and FIG. 5B are also applicable to the apparatus 600, and details are not described herein again.

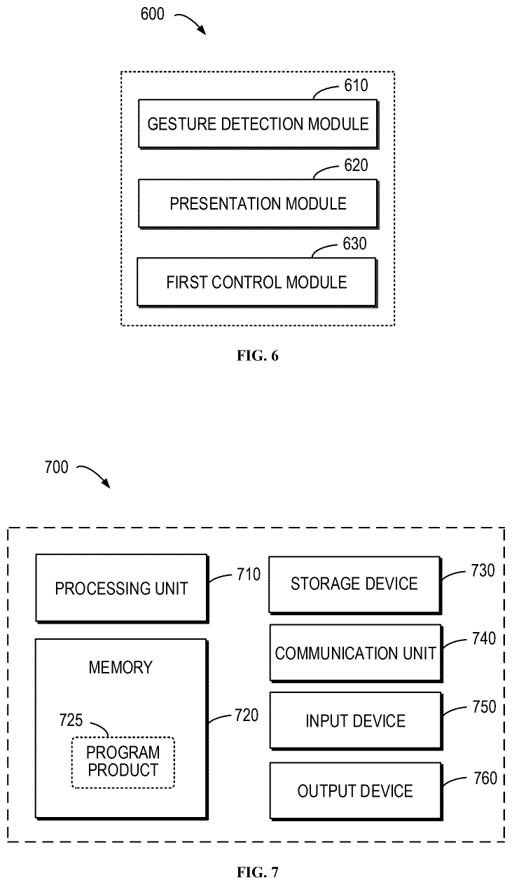

FIG. 7 illustrates a block diagram of an electronic device 700 in which one or more embodiments of the present disclosure may be implemented. For example, the electronic device 700 may be configured to implement an information processing process according to the embodiments of the present disclosure. The electronic device 700 shown in FIG. 7 is merely exemplary and does not constitute any limitation on the functionality and scope of the embodiments described herein.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data (e.g., training data for training) and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, and the like, communicate with one or more devices that enable a user to interact with the electronic device 700, or communicate with any device (e.g., a network card, a modem, and the like.) that enables the electronic device 700 to communicate with one or more other electronic devices. Such communication may be performed via an input/output (I/O) interface (not shown).

According to example implementations of the present disclosure, there is provided a computer-readable storage medium having one or more computer instructions stored thereon, wherein one or more computer instructions are executed by a processor to implement the method described above.

Aspects of the present disclosure are described herein with reference to flowcharts and/or block diagrams of methods, apparatuses (systems), and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may also be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the implementations disclosed herein.

1. A method of augmented reality, AR, comprising:
detecting a target gesture made by a user, at least one finger of the user having a predetermined shape in the target gesture;
in response to detecting the target gesture, presenting an avatar in an AR environment, at least a portion of the avatar matching the predetermined shape in appearance; and
in response to detecting a change of the target gesture, controlling an action of the avatar in the AR environment based at least on the change.

2. The method of claim 1, wherein the at least one finger comprises two or more fingers.

3. The method of claim 2, wherein controlling the action of the avatar in the AR environment comprises:
controlling an angle between a first component and a second component of the at least one portion, based on a change of an angle between the two or more fingers.

4. The method of claim 2, wherein controlling the action of the avatar in the AR environment comprises:
controlling bending of at least one component of the at least one portion based on bending of at least one of the two or more fingers.

5. The method of claim 2, further comprising:
in response to detecting that bending of the two or more fingers exceeds a threshold degree, ceasing to display the avatar in the AR environment.

6. The method of claim 1, wherein controlling the action of the avatar in the AR environment comprises:
controlling an orientation of the avatar in the AR environment based at least on a rotation of a hand making the target gesture.

7. The method of claim 6, wherein controlling the orientation of the avatar in the AR environment comprises:
determining the orientation of the avatar in the AR environment based on the rotation of the hand;
modify the orientation by using an orientation calibration factor, to cause a predetermined face of the avatar to rotate towards a presentation interface of the AR environment by an angle; and
presenting the avatar in the AR environment according to the modified orientation.

8. The method of claim 1, further comprising:
in response to detecting that the target gesture is changed to a different predetermined gesture, presenting, in the AR environment, an effect corresponding to the predetermined gesture.

9. The method of claim 1, further comprising:
in response to detecting the change of the target gesture, controlling an expression of the avatar based at least on the change.

10. The method of claim 1, further comprising:
detecting an expression of a face of the user; and
controlling an action of the avatar and/or an expression of the avatar in the AR environment, according to the detected expression of the face.

11. The method of claim 1, wherein the at least a portion of the avatar is elastic, and wherein controlling the act of the avatar in the AR environment comprises:
controlling a deformation of the at least a portion based on the change of the gesture and a mechanical simulation associated with the at least a portion of the avatar.

12. The method of claim 10, wherein controlling the deformation of the at least a portion comprises:
determining a first posture of the at least a portion based on a bending degree of the finger;
calculating, based on the first posture, simulated gravity and simulated stress of a plurality of predetermined nodes in the at least a portion;
determining a bending angle of each of a plurality of segments of the at least a portion with respect to a previous segment of the plurality of segments, based on the simulated gravity and the simulated stress, the plurality of segments being defined by the plurality of nodes; and
adjusting the first posture according to the bending angle to obtain a second posture of the at least a portion.

13. The method of claim 12, wherein controlling the deformation of the at least a portion comprises:
controlling the deformation further based on simulated resistance experienced by the at least a portion in the AR environment.

14. An apparatus for augmented reality, AR, comprising:
a gesture detection module configured to detect a target gesture made by a user, at least one finger of the user having a predetermined shape in the target gesture;
a presentation module configured to in response to detecting the target gesture, present an avatar in an AR environment, at least a portion of the avatar matching the predetermined shape in appearance; and
a first control module configured to in response to detecting a change of the target gesture, control an action of the avatar in the AR environment based at least on the change.

15. The apparatus of claim 14, wherein the at least one finger comprises two or more fingers.

16. The apparatus of claim 15, wherein the first control module is configured to:
control an angle between a first component and a second component of the at least one portion based on a change in an angle between the two or more fingers.

17. The apparatus of claim 15, wherein the first control module is configured to:
control bending of at least one component of the at least one portion based on bending of at least one of the two or more fingers.

18. The apparatus of claim 14, wherein the first control module is configured to:
determine an orientation of the avatar in the AR environment based on a rotation of a hand making the target gesture;
modify an orientation by using an orientation calibration factor to cause a predetermined face of the avatar to rotate towards a presentation interface of the AR environment by a certain angle; and
present the avatar in the AR environment according to the modified orientation.

19. An electronic device comprising:
at least one processing unit; and
at least one memory coupled to the at least one processing unit and storing instructions for execution by the at least one processing unit, the instructions, when executed by the at least one processing unit, causing the apparatus to perform acts comprising:
detecting a target gesture made by a user, at least one finger of the user having a predetermined shape in the target gesture;
in response to detecting the target gesture, presenting an avatar in an AR environment, at least a portion of the avatar matching the predetermined shape in appearance; and
in response to detecting a change of the target gesture, controlling an action of the avatar in the AR environment based at least on the change.

20. A non-transitory computer-readable storage medium having a computer program stored thereon, which, when executed by a processor,
perform acts comprising:
detecting a target gesture made by a user, at least one finger of the user having a predetermined shape in the target gesture;
in response to detecting the target gesture, presenting an avatar in an AR environment, at least a portion of the avatar matching the predetermined shape in appearance; and
in response to detecting a change of the target gesture, controlling an action of the avatar in the AR environment based at least on the change.
